(19) United States
(12) Patent Application Publication
(10) Pub. No.: US 2021/0099058 A1
(43) Pub. Date: Apr. 1, 2021

(54) WIRE BONDING DEVICE OF STATOR OF MOTOR

(71) Applicant: Chicony Power Technology Co., Ltd., New Taipei City (TW)

(72) Inventors: Chien-Chuan LIAO, New Taipei City (TW); Yu-Hsing HUANG, New Taipei City (TW)

(21) Appl. No.: 16/716,527

(22) Filed: Dec. 17, 2019

(30) Foreign Application Priority Data
Sep. 26, 2019 (TW) 108134934

(51) Int. Cl. H02K 15/00; H02K 15/02

(52) U.S. Cl. CPC H02K 15/0068; H02K 15/02

(57) ABSTRACT

A wire bonding device of a stator of a motor includes insulating rings, an insulating cover, and conductors. Each insulating ring has first and second fixing structures disposed thereon. The insulating rings are stacked layer by layer with the first fixing structures corresponding to the second fixing structures. The insulating cover covers an uppermost one of the insulating rings. Each conductor includes an embedded segment, two bending segments, two protruding segments, and two wire-bonding segments. The embedded segment is accommodated in a corresponding insulating ring and has a flat strip shape. The bending segments are integrally extended from two ends of the embedded segment respectively and bended relative to the embedded segment. The protruding segments are integrally extended from the bending segments and protrude out of the corresponding insulating ring. The wire-bonding segments are integrally extended from the protruding segments and located outside the insulating ring.

### RELATED APPLICATIONS

This application claims priority to Taiwan Application Serial Number 108134934, filed Sep. 26, 2019, which is herein incorporated by reference.

### BACKGROUND

### Technical Field

The present disclosure relates to a wire bonding device of a stator of a motor.

### Description of Related Art

In the generation that technologies increasingly advance, the electrical motor industry is one of the cores of the modern industries. A motor is an electrical device that converts electrical energy into kinetic energy, and the power and the stability of the motor progress with each passing day. To reduce the motor size and ease of assembly are very important issues of the industry.

However, the processes of wiring a present motor are complicated. Not only is the amount of the used copper wires hard to be reduced, but the convenience of operation is also influenced. Specifically, in the conventional arts, the wiring processes between the wiring coils and conductive coils are performed in manual way, which are more complex and time-consuming, so that the labor costs remain high.

### SUMMARY

An aspect of the disclosure is to provide a wire bonding device of a stator of a motor which can effectively reduce artificial assembly errors and facilitate disassembly, assembly, and adjustment.

According to an embodiment of the disclosure, a wire bonding device of a stator of a motor includes a plurality of insulating rings, an insulating cover, and a plurality of conductors. Each of the insulating rings has a first fixing structure and a second fixing structure disposed thereon. The insulating rings are stacked layer by layer with the first fixing structures corresponding to the second fixing structures. The insulating cover covers an uppermost one of the insulating rings. Each of the conductors includes an embedded segment, two bending segments, two protruding segments, and two wire-bonding segments. The embedded segment is accommodated in a corresponding one of the insulating rings and has a flat strip shape. The two bending segments are integrally extended from two ends of the embedded segment respectively and bended relative to the embedded segment. The two protruding segments are integrally extended from the two bending segments respectively and protrude out of the corresponding one of the insulating rings. The two wire-bonding segments are integrally extended from the two protruding segments respectively and located outside the corresponding one of the insulating rings.

In an embodiment of the disclosure, each of the insulating rings includes a sidewall and a bottom. The bottom is connected to the sidewall and has an upper surface and a lower surface. The first fixing structure and the second fixing structure are respectively disposed on the upper surface and the lower surface.

In an embodiment of the disclosure, each of the insulating rings further includes a buckle and a slot. The buckle is disposed on the sidewall. The slot is disposed on the sidewall. Each of the insulating rings is stacked with another of the insulating rings by engaging the buckle thereon with the slot of said another of the insulating rings.

In an embodiment of the disclosure, each of the insulating rings further includes another sidewall. One of the sidewall and said another sidewall has two openings. The two bending segments protrude out of the corresponding one of the insulating rings via the two openings respectively.

In an embodiment of the disclosure, each of the insulating rings further includes a rib disposed on the upper surface. The rib and one of the sidewall and said another sidewall form an accommodating space therebetween. The accommodating space is configured to accommodate a corresponding one of the embedded segments.

In an embodiment of the disclosure, one of the two wire-bonding segments includes a wire-bonding portion and a rising portion. The wire-bonding portion has a first notch. An end of the rising portion is connected to the wire-bonding portion. Another end of the wire-bonding portion is connected to a corresponding one of the protruding segments.

In an embodiment of the disclosure, said one of the two wire-bonding segments further includes a fixing portion. An end of the fixing portion is connected to the rising portion. The fixing portion has a second notch.

In an embodiment of the disclosure, entrances of the first notch and the second notch are oriented in different directions.

In an embodiment of the disclosure, the first notch and the second notch are extended and bended toward a surface of the rising portion.

In an embodiment of the disclosure, the wire-bonding portion further has a third notch. Heights of the first notch and the third notch relative to the rising portion are different.

In an embodiment of the disclosure, entrances of the first notch and the third notch are oriented in an identical direction.

In an embodiment of the disclosure, the first notch is extended and bended toward a surface of the rising portion. The third notch is extended and bended toward another surface of the rising portion.

In an embodiment of the disclosure, the first fixing structure and the second fixing structure respectively are a bump structure and a recess structure configured to be engaged with the bump structure.

In an embodiment of the disclosure, the conductors that are disposed on an identical one of the insulating rings are connected to cables having an identical phase.

In an embodiment of the disclosure, the conductors that are disposed on different ones of the insulating rings are connected to cables having different phases.

Accordingly, in the wire bonding device of a stator of a motor of the present disclosure, since the insulating rings are stacked layer by layer with the first fixing structures corresponding to the second fixing structures, the insulating rings can be rapidly aligned by adjusting the angles of the insulating rings of all phases by rotating, so as to facilitate the installation and adjustment of the insulating rings. Furthermore, by designing notches at lateral edges of the wire-bonding segments of the conductors that are exposed outside the insulating rings, all of the conductors can simultaneously contact the junction wires and be fixed by rotating the insulating rings of all phases, thereby achieving the purpose of rapidly completing the operation of fixing the junction wires. Moreover, by forming the accommodating space having a specific shape between the sidewall and the rib of each insulating ring for accommodating the embedded segments of the conductors, the relative positions between the insulating rings and the conductors can be effectively maintained.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is an exploded view of a wire bonding device of a stator of a motor and a bobbin according to an embodiment of the disclosure;

FIG. 2A is an exploded view of the wire bonding device as shown in FIG.

1;

FIG. 2B is another exploded view of the wire bonding device as shown in FIG. 1;

FIG. 3A is a top view of one of insulating rings and corresponding conductors as shown in FIG. 2A;

FIG. 3B is an exploded view of one of the insulating rings and the corresponding conductors as shown in FIG. 2A;

FIG. 4 is a partial perspective view of a conductor according to an embodiment of the disclosure; and

FIG. 5 is a partial perspective view of a conductor according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

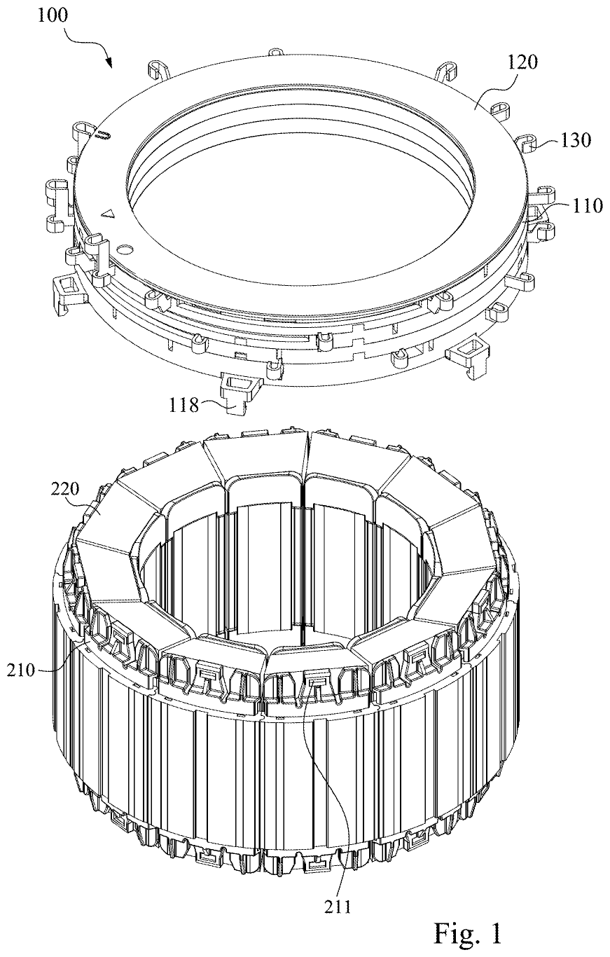

Reference is made to FIG. 1. FIG. 1 is an exploded view of a wire bonding device 100 of a stator of a motor and a bobbin 210 according to an embodiment of the disclosure.

As shown in FIG. 1, in the present embodiment, the wire bonding device 100 is configured to be fixed to the bobbin 210. For example, in the present embodiment, the wire bonding device 100 includes a plurality of buckles 118 (only one of which is representatively labeled in FIG. 1), and the bobbin 210 has a plurality of slots 211 (only one of which is representatively labeled in FIG. 1). The buckles 118 are detachably engaged with the slots 211 respectively, so as to fix the wire bonding device 100 and the bobbin 210.

In some embodiments, at least one of the buckles 118 on the wire bonding device 100 can be exchanged with the corresponding slots 211 on the bobbin 210, and the purpose of fixing the wire bonding device 100 and the bobbin 210 can also be achieved. In practical applications, the wire bonding device 100 can also be fixed by junction wires (not shown) extended from the bobbin 210.

As shown in FIG. 1, in the present embodiment, the bobbin 210 is wound with a plurality of winding groups 220 (only one of which is representatively labeled in FIG. 1) of a stator of a motor. Specifically, in the present embodiment, a number of the winding groups 220 wound around the bobbin 210 is twelve, but the disclosure is not limited in this regard.

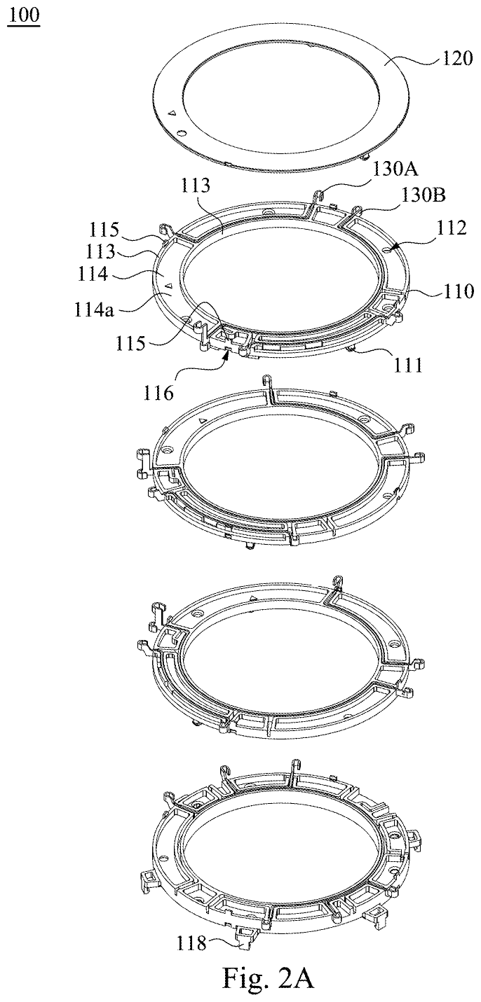

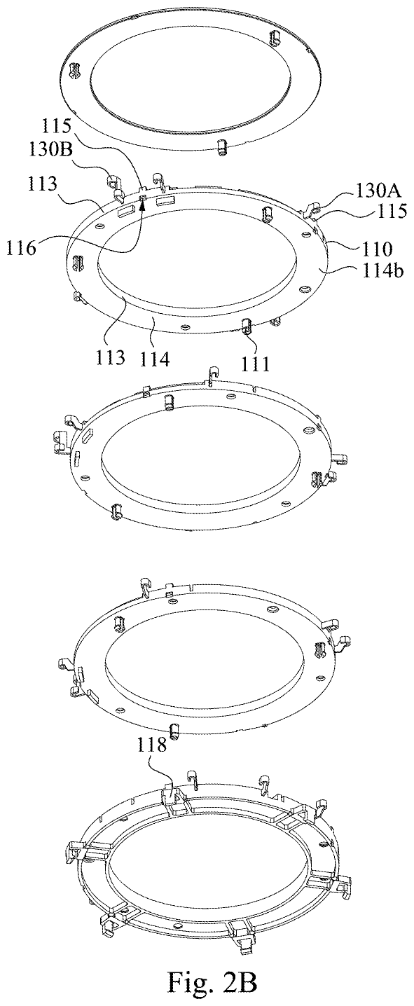

Reference is made to FIGS. 2A and 2B. FIG. 2A is an exploded view of the wire bonding device 100 as shown in FIG. 1. FIG. 2B is another exploded view of the wire bonding device 100 as shown in FIG. 1. As shown in FIGS. 1-2B, in the present embodiment, the wire bonding device 100 includes a plurality of insulating rings 110, an insulating cover 120, and a plurality of conductors 130A, 130B. The insulating cover 120 covers an uppermost one of the insulating rings 110. The conductors 130A, 130B are located between adjacent two of the insulating rings 110 or between the insulating cover 120 and the adjacent one of the insulating rings 110. Each of the insulating rings 110 includes a sidewall 113 and a bottom 114. The bottom 114 is connected to the sidewall 113 and has an upper surface 114a and a lower surface 114b. Each of the insulating rings 110 further has a first fixing structure 111 and a second fixing structure 112 disposed thereon. The first fixing structure 111 and the second fixing structure 112 are respectively disposed on the upper surface 114a and the lower surface 114b (respectively shown in FIGS. 2A and 2B). The insulating rings 110 are stacked layer by layer with the first fixing structures 111 corresponding to the second fixing structures 112. The buckles 118 shown in FIG. 1 are disposed on one of the insulating rings 110 (i.e., the lowermost one of the insulating rings 110).

As shown in FIGS. 2A and 2B, in the present embodiment, each of the insulating rings 110 further includes a plurality of buckles 115 and a plurality of slots 116. The buckles 115 are disposed on the sidewall 113. The slots 116 are also disposed on the sidewall 113. Each of the insulating rings 110 is stacked with another of the insulating rings 110 by engaging the buckles 115 thereon with the slots 116 of said another of the insulating rings 110.

With the foregoing structural configurations, after rapidly aligning the first fixing structures 111 with the second fixing structures 112 by adjusting the insulating rings 110 of all phases by rotating, the insulating rings 110 can then be fixed to each other by engaging the buckles 115 with the slots 116, so as to facilitate the installation and adjustment of the insulating rings 110.

In the present embodiment, the wire bonding device 100 includes four layers of insulating rings 110 which can be subdivided into the insulating rings 110 of three phases U, V, and W (i.e., the upper three insulating rings 110 shown in FIG. 2A) and the insulating ring 110 of the common point Y (i.e., the lowermost insulating ring 110 shown in FIG. 2A), in which parts of the insulating rings 110 of the three phases can be shared. It should be pointed out that in the present embodiment, the conductors 130A, 130B that are disposed on an identical one of the insulating rings 110 are connected to cables having an identical phase, and the conductors 130A, 130B that are disposed on different ones of the insulating rings 110 are connected to cables having different phases.

As shown in FIGS. 2A and 2B, in the present embodiment, the first fixing structure 111 and the second fixing structure 112 respectively are a bump structure and a recess structure configured to be engaged with the bump structure. In some other embodiments, the first fixing structure 111 and the second fixing structure 112 can respectively be a recess structure and a bump structure.

In some embodiments, the materials of the insulating rings 110 and the insulating cover 120 include plastics and glass fibers to avoid electrical connections among the conductors 130A, 130B which cause short circuits. For example, the plastics includes polyethylene terephthalate, but the disclosure is not limited in this regard.

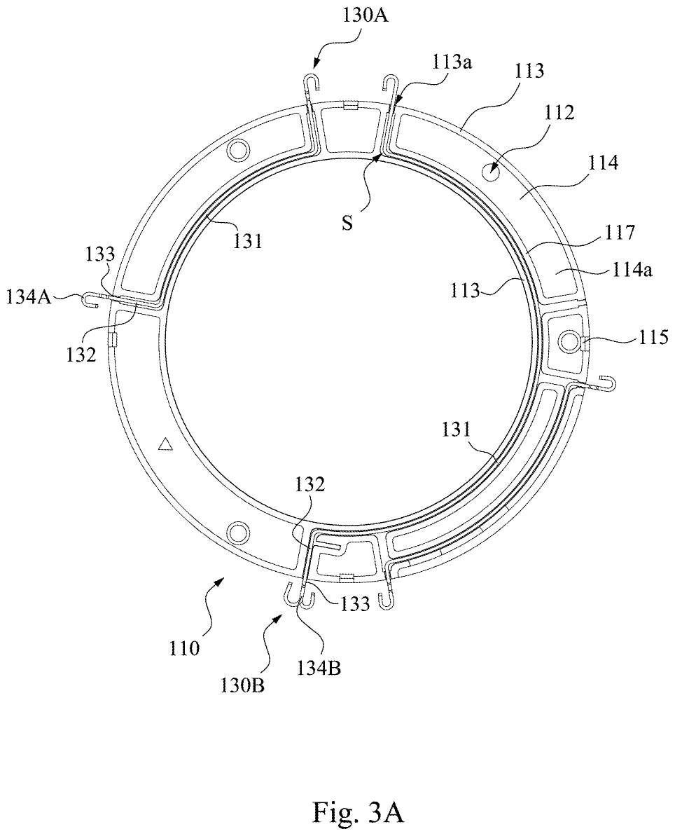

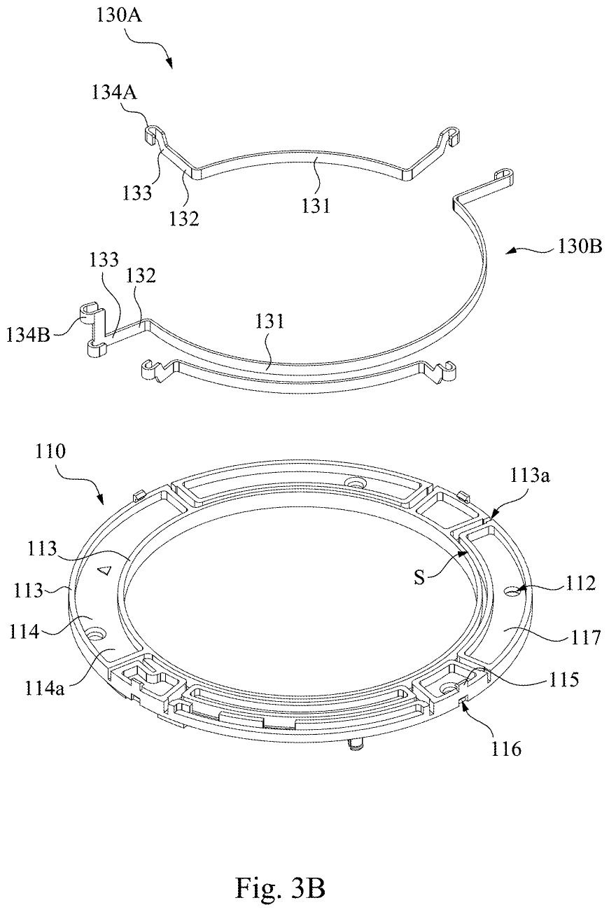

Reference is made to FIGS. 3A and 3B. FIG. 3A is a top view of one of insulating rings 110 and corresponding conductors 130A, 130B as shown in FIG. 2A. FIG. 3B is an exploded view of one of the insulating rings 110 and the corresponding conductors 130A, 130B as shown in FIG. 2A. Hereinafter, one of the insulating rings 110 and the conductors 130A, 130B accommodated therein will be described as an example. As shown in FIGS. 3A and 3B, in the present embodiment, each of the conductors 130A, 130B includes an embedded segment 131, two bending segments 132, two protruding segments 133, and two wire-bonding segments 134A or 134B. The embedded segment 131 is accommodated in a corresponding one of the insulating rings 110 and has a flat strip shape, and the shape conforms to a part of the shape of the corresponding insulating ring 110 and is curved. The two bending segments 132 are integrally extended from two ends of the embedded segment 131 respectively and bended relative to the embedded segment 131. The two protruding segments 133 are integrally extended from the two bending segments 132 respectively and protrude out of the corresponding one of the insulating rings 110. The two wire-bonding segments 134A or 134B are integrally extended from the two protruding segments 133 respectively and located outside the corresponding one of the insulating rings 110.

Furthermore, each of the insulating rings 110 further includes inner and outer sidewalls 113. The outer sidewall 113 in the present embodiment has a plurality of openings 113a. The two bending segments 132 of the conductors 130A or 130B protrude out of the corresponding one of the insulating rings 110 via the two openings 113a respectively. In other words, boundaries between the bending segments 132 and the protruding segments 133 of the conductors 130A or 130B can be determined based on the openings 113a. In some other embodiments, the openings 113a can be changed to be formed on the inner sidewall 113 of each of the insulating rings 110.

In addition, each of the insulating rings 110 further includes ribs 117. The ribs 117 are disposed on the upper surface 114a of the bottom 114, and the ribs 117 and one of the sidewalls 113 form an accommodating space S therebetween. The accommodating space S is configured to accommodate the embedded segments of the corresponding conductors 130A or 130B. By forming the accommodating space S having a specific shape between the sidewall 113 and the ribs 117 of each insulating ring 110 for accommodating the embedded segments 131 of the conductors 130A or 1308, the relative positions between the insulating rings 110 and the conductors 130A or 130B can be effectively maintained.

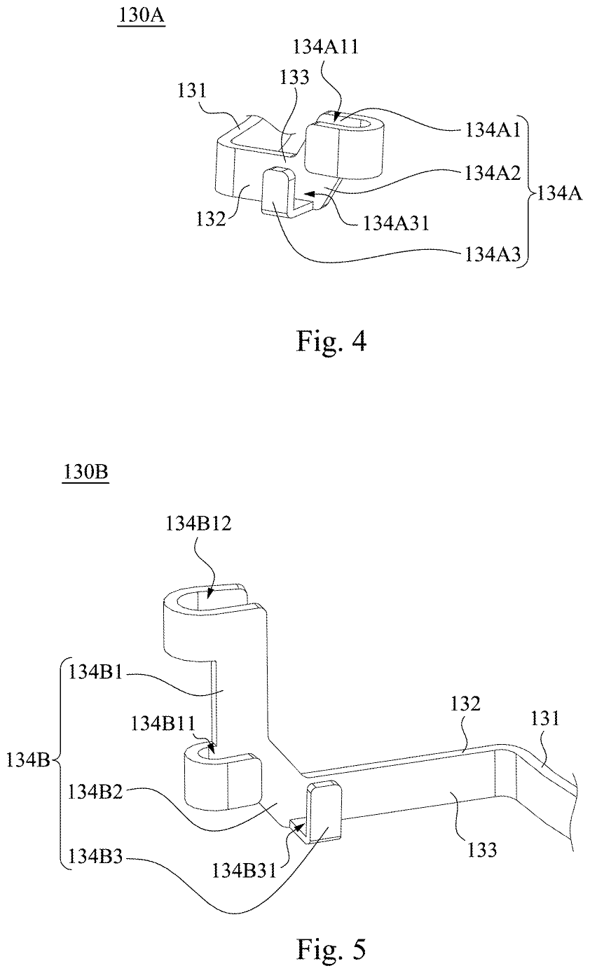

Reference is made to FIG. 4. FIG. 4 is a partial perspective view of a conductor 130A according to an embodiment of the disclosure. As shown in FIG. 4, in the present embodiment, one of the wire-bonding segments 134A of the conductor 130A includes a wire-bonding portion 134A1 and a rising portion 134A2. The wire-bonding portion 134A1 has a first notch 134A11. The first notch 134A11 is configured to be fixed to a junction wire extended from the bobbin 210. An end of the rising portion 134A2 is connected to the wire-bonding portion 134A1. Another end of the wire-bonding portion 134A1 is connected to a corresponding one of the protruding segments 133. It is noted that the junction wire extended from below is an enameled wire (i.e., a metal material coated with one or more insulating paint films). When the junction wire is fixed, an excess part of the insulating paint films is scraped off after the junction wire passes through the first notch 134B11, and then a welding process is performed.

With the design of the first notch 134B11, the conductor 130A can contact the junction wire and be fixed by rotating the insulating rings 110 of all phases, thereby achieving the purpose of rapidly completing the operation of fixing the junction wires.

In some embodiments, the connection between the first notch 134A11 of the wire-bonding portion 134A1 and the junction wire extended from the bobbin 210 may be formed by, for example, soldering, arc welding, laser welding, ultrasonic welding, or resistance welding. With the design of the rising portion 134A2, the welding rod can be out of the way during welding, thereby facilitating automated production.

Also shown in FIG. 4, in the present embodiment, the foregoing wire-bonding segment 134A further includes a fixing portion 134A3. An end of the fixing portion 134A3 is connected to the rising portion 134A2 and has a second notch 134A31. Entrances of the first notch 134A11 and the second notch 134A31 are oriented in different directions. Specifically, as shown in FIG. 4, the entrance of the first notch 134A11 is oriented to the left, and the entrance of the second notch 134A31 is oriented upward. In some other embodiments, the outer sidewall 113 of the insulating ring 110 can be radially extended with a protruding structure (not shown) passing through the second notch 134A31 and pressing the fixing portion 134A3, so that the conductor 130A is not easily separated from the insulating ring 110.

In some embodiments, as shown in FIG. 4, the first notch 134A11 and the second notch 134A31 are extended and bended toward a surface of the rising portion 134A2 (i.e., the first notch 134A11 and the second notch 134A31 are located at the same side of the rising portion 134A2). By designing the first notch 134A11 and the second notch 134A31 to be bended in the same direction, the bending can be easily performed to facilitate the integral forming process.

Reference is made to FIG. 5. FIG. 5 is a partial perspective view of a conductor 1306 according to an embodiment of the disclosure. As shown in FIG. 5, in the present embodiment, one of the wire-bonding segments 134B of the conductor 1306 includes a wire-bonding portion 134B1, a rising portion 134B2, and a fixing portion 134B3. The wire-bonding portion 134B1 has a first notch 134B11. The first notch 134B11 is configured to be fixed to a junction wire extended from the bobbin 210. An end of the rising portion 134B2 is connected to the wire-bonding portion 134B1. Another end of the wire-bonding portion 134B1 is connected to a corresponding one of the protruding segments 133. An end of the fixing portion 134B3 is connected to the rising portion 134B2 and has a second notch 134B31. The shapes of the rising portion 134B2 and the fixing portion 134B3 included in the wire-bonding segment 134B and the relative position between the two are similar to those of the wire-bonding segment 134A shown in FIG. 4, so reference may be made to the above related description and would not repeated here for simplicity.

It should be pointed out that compared to the wire-bonding segment 134A shown in FIG. 4, the wire-bonding segment 134B shown in FIG. 5 further has a third notch 134B12. Heights of the first notch 134B11 and the third notch 134B12 relative to the rising portion 134B2 are different. Thereby, when welding the junction wire, the welding failure caused by the electrode head simultaneously clamping the first notch 134B11 and the third notch 134B12 at different heights can be prevented. Similarly, when the junction wire is fixed, an excess part of the insulating paint films is scraped off after the junction wire passes through the third notch 134B12, and then a welding process is performed. It is noted that the junction wire fixed by the third notch 134B12 is a three phase power line.

In some embodiments, as shown in FIG. 5, entrances of the first notch 134B11 and the third notch 134B12 are oriented in an identical direction. Specifically, as shown in FIG. 5, the entrances of the first notch 134B11 and the third notch 134B12 are both oriented to the right. By designing the entrances of the first notch 134B11 and the third notch 134B12 to be oriented to the same direction, the insulating paint film of the junction wire extended from below can be cut off in the same rotating direction.

In some other embodiments, as shown in FIG. 5, the first notch 134B11 is extended and bended toward a surface of the rising portion 134B2. The third notch 134B12 is extended and bended toward another surface of the rising portion 134B2 (i.e., the first notch 134B11 and the third notch 134B12 are located at different sides of the rising portion 134B2). By designing the first notch 134B11 and the third notch 134B12 to be bended in opposite directions, the cutting operation of the insulating paint film can be facilitated.

In some embodiments, the surface of the conductor 130A or 1306 may be partially insulated or not insulated.

As shown in FIG. 1 with reference to FIG. 2A, in the present embodiment, a total number of the first notches 134A11, 134B11 of the conductors 130A, 1306 and the third notch 134B12 is twice the number of the winding groups 220.

For example, in the present embodiment, the total number of the first notches 134A11, 134B11 of the conductors 130A, 130B and the third notch 134B12 may correspond the number of the winding groups 220 to be twenty four, but the disclosure is not limited in this regard.

According to the foregoing recitations of the embodiments of the disclosure, it can be seen that in the wire bonding device of a stator of a motor of the present disclosure, since the insulating rings are stacked layer by layer with the first fixing structures corresponding to the second fixing structures, the insulating rings can be rapidly aligned by adjusting the angles of the insulating rings of all phases by rotating, so as to facilitate the installation and adjustment of the insulating rings. Furthermore, by designing notches at lateral edges of the wire-bonding segments of the conductors that are exposed outside the insulating rings, all of the conductors can simultaneously contact the junction wires and be fixed by rotating the insulating rings of all phases, thereby achieving the purpose of rapidly completing the operation of fixing the junction wires. Moreover, by forming the accommodating space having a specific shape between the sidewall and the rib of each insulating ring for accommodating the embedded segments of the conductors, the relative positions between the insulating rings and the conductors can be effectively maintained.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wire bonding device of a stator of a motor, the wire bonding device comprising:
a plurality of insulating rings each having a first fixing structure and a second fixing structure disposed thereon, wherein the insulating rings are stacked layer by layer with the first fixing structures corresponding to the second fixing structures;
an insulating cover covering an uppermost one of the insulating rings; and
a plurality of conductors each comprising:
an embedded segment accommodated in a corresponding one of the insulating rings and having a flat strip shape;
two bending segments integrally extended from two ends of the embedded segment respectively and bended relative to the embedded segment;
two protruding segments integrally extended from the two bending segments respectively and protruding out of the corresponding one of the insulating rings; and
two wire-bonding segments integrally extended from the two protruding segments respectively and located outside the corresponding one of the insulating rings.

2. The wire bonding device of claim 1, wherein each of the insulating rings comprises:
a sidewall; and
a bottom connected to the sidewall and having an upper surface and a lower surface, wherein the first fixing structure and the second fixing structure are respectively disposed on the upper surface and the lower surface.

3. The wire bonding device of claim 2, wherein each of the insulating rings further comprises:
a buckle disposed on the sidewall; and
a slot disposed on the sidewall,
wherein each of the insulating rings is stacked with another of the insulating rings by engaging the buckle thereon with the slot of said another of the insulating rings.

4. The wire bonding device of claim 2, wherein each of the insulating rings further comprises another sidewall, one of the sidewall and said another sidewall has two openings, and the two bending segments protrude out of the corresponding one of the insulating rings via the two openings respectively.

5. The wire bonding device of claim 4, wherein each of the insulating rings further comprises a rib disposed on the upper surface, the rib and one of the sidewall and said another sidewall form an accommodating space therebetween, and the accommodating space is configured to accommodate a corresponding one of the embedded segments.

6. The wire bonding device of claim 1, wherein one of the two wire-bonding segments comprises:
a wire-bonding portion having a first notch; and
a rising portion, an end of the rising portion being connected to the wire-bonding portion, another end of the wire-bonding portion being connected to a corresponding one of the protruding segments.

7. The wire bonding device of claim 6, wherein said one of the two wire-bonding segments further comprises a fixing portion, an end of the fixing portion is connected to the rising portion, and the fixing portion has a second notch.

8. The wire bonding device of claim 7, wherein entrances of the first notch and the second notch are oriented in different directions.

9. The wire bonding device of claim 7, wherein the first notch and the second notch are extended and bended toward a surface of the rising portion.

10. The wire bonding device of claim 7, wherein the wire-bonding portion further has a third notch, and heights of the first notch and the third notch relative to the rising portion are different.

11. The wire bonding device of claim 10, wherein entrances of the first notch and the third notch are oriented in an identical direction.

12. The wire bonding device of claim 10, wherein the first notch is extended and bended toward a surface of the rising portion, and the third notch is extended and bended toward another surface of the rising portion.

13. The wire bonding device of claim 1, wherein the first fixing structure and the second fixing structure respectively are a bump structure and a recess structure configured to be engaged with the bump structure.

14. The wire bonding device of claim 1, wherein the conductors that are disposed on an identical one of the insulating rings are connected to cables having an identical phase.

15. The wire bonding device of claim 1, wherein the conductors that are disposed on different ones of the insulating rings are connected to cables having different phases.
